(19) United States
(12) Patent Application Publication
(10) Pub. No.: US 2026/0014399 A1
(43) Pub. Date: Jan. 15, 2026

(54) FIREFIGHTER FOAM IN A BAG AND METHODS OF USE

(71) Applicant: Battelle Memorial Institute, Columbus, OH (US)

(72) Inventors: Josh HEBERT, Panama City, FL (US); Thomas HAMNER, Plain City, OH (US); Melissa S. ROSHON, Hilliard, OH (US)

(73) Assignee: BATTELLE MEMORIAL INSTITUTE, Columbus, OH (US)

(21) Appl. No.: 19/270,188

(22) Filed: Jul. 15, 2025

Related U.S. Application Data
(60) Provisional application No. 63/671,601, filed on Jul. 15, 2024.

(51) Int. Cl. A62C 5/027

(52) U.S. Cl. CPC A62C 5/027

(57) ABSTRACT

An apparatus, system, and method for firefighting foam in a bag is disclosed. A firefighting foam in a bag system includes a firefighting foam in a bag apparatus. The apparatus comprises an outer container configured to provide structural support and protection, an internal collapsible bag disposed within the outer container to store foam concentrate and collapse as the concentrate is dispensed, and a connection mechanism for detachably securing the internal collapsible bag within the outer container. The system further includes a foam proportioning device configured to mix the foam concentrate from the internal collapsible bag with water to create a foam solution, operatively connected to both the internal collapsible bag and a water supply. Additionally, the system includes a discharge device configured to apply the foam solution to a fire-affected area, operatively coupled to the foam proportioning device.

### CROSS-REFERENCE TO RELATED APPLICATIONS

This U.S. Non-Provisional Patent Application claims priority to U.S. Provisional Patent Application Ser. No. 63/671,601, filed on Jul. 15, 2024, entitled “Firefighter Foam in a Bag and Methods of Use,” and which patent application is commonly owned by the owner of the present invention. This patent application is hereby incorporated by reference in its entirety for all purposes.

### TECHNICAL FIELD

The present disclosure pertains to the field of firefighting equipment and, more specifically, to systems and methods for the storage, application, and disposal of firefighting foam. The invention relates to a novel container system designed for use in firefighting operations, where the effective use of foam is essential for extinguishing fires and preventing burn back. This system addresses the challenges of foam degradation, environmental toxicity, equipment corrosion, and foam shelf-life, particularly with the transition to fluorine-free foams (FFF).

### BACKGROUND

The field of firefighting is crucial for ensuring the safety of lives and property. Firefighters have often used foam to extinguish fires and prevent fire burn back, an essential practice in combating various types of fires. While firefighting foam is effective in suppressing fires, its use comes with significant challenges and limitations.

One of the primary concerns with firefighting foam is its environmental impact. Traditional foams often contain perfluoroalkyl and polyfluoroalkyl substances (PFAS), which are persistent environmental pollutants. Recognizing the potential hazards, the Department of Defense (DoD) has initiated a transition to fluorine-free foams to reduce environmental toxicity. However, this shift presents new challenges in foam formulation and application.

Fluorine-free foams, while environmentally safer, exhibit issues with shelf life, mixing ability, and application. These foams tend to solidify upon exposure to air, corrode from the stock solution, or mix in a non-Newtonian manner, complicating their use in firefighting operations. Current foam proportioning systems are often inadequate to handle both legacy foams and novel fluorine-free foams, leading to inefficiencies and potential equipment degradation.

Additionally, the storage and handling of firefighting foam present logistical difficulties. Traditional foam storage solutions are prone to oxygenation, which degrades the foam's effectiveness over time. Fire departments frequently encounter equipment malfunctions related to foam tanks, which further complicate the use of these essential fire suppression tools. The degradation of foam, coupled with potential corrosion and compatibility issues with existing firefighting equipment, highlights the need for improved storage and application systems.

Fire departments and emergency responders require a reliable, efficient system for storing and deploying firefighting foam that addresses these challenges. A system that minimizes environmental impact, extends foam shelf life, and integrates seamlessly with existing equipment is essential for effective firefighting operations. Furthermore, ensuring that the system limits personnel exposure to the foam and mitigates the risk of equipment corrosion is crucial for operational safety and efficiency.

Thus, there is a pressing need for innovative solutions in the field of firefighting foam storage and application. The development of a collapsible, airtight container system that can integrate with existing firefighting equipment, prevent foam degradation, limit personnel exposure, and reduce environmental impact would significantly enhance the effectiveness and reliability of firefighting operations. This system should be versatile enough to handle both fluorine-free foams and legacy foams, providing a comprehensive solution to the challenges faced presently by firefighting teams.

### SUMMARY OF THE DISCLOSURE

The present disclosure is directed to a novel firefighting foam storage and application system, specifically designed to address the challenges associated with the use of fluorine-free foams (FFF) in firefighting operations. This system includes a two-part container with a hard plastic outer shell and an internal collapsible bag, an application device that integrates with existing firefighting equipment, and methods for both the use and disposal of the foam in a bag.

To address the needs in the field of firefighting foam application and storage, the system offers several advantages. First, the collapsible container prevents foam degradation due to oxygenation, thereby extending the shelf life of both legacy and fluorine-free foams. By minimizing contact with personnel and equipment, the system reduces the risk of environmental contamination and equipment corrosion. Additionally, the design of the firefighting foam in a bag apparatus ensures compatibility with an existing firefighting apparatus, facilitating a seamless transition to fluorine-free foams for the system. This innovative solution provides a reliable, efficient, and environmentally friendly method for storing and deploying firefighting foam, enhancing the effectiveness and safety of firefighting operations.

Accordingly, in certain embodiments, the system enhances the storage, application, and disposal of firefighting foam, especially fluorine-free foams. The design, featuring a collapsible internal container and a compatible application device, significantly reduces foam degradation and prolongs shelf life. This represents a cost-effective, sustainable alternative to traditional foam storage and application methods, marking a substantial advancement in firefighting technology. The integration with existing equipment and the reduced exposure of personnel and equipment to the foam improve operational safety and efficiency. The versatile design ensures compatibility with both legacy and fluorine-free foams, offering a comprehensive and reliable solution for modern firefighting requirements.

In general, in one embodiment, the disclosure features a firefighting foam in a bag system, including a firefighting foam in a bag apparatus, where the firefighting foam in a bag apparatus includes an outer container configured to provide structural support and protection, an internal collapsible bag disposed within the outer container, where the internal collapsible bag is configured to store foam concentrate and to collapse as foam concentrate is dispensed, and a connection mechanism for detachably securing the internal collapsible bag within the outer container; a foam proportioning device configured to mix the foam concentrate from the internal collapsible bag with water to create a foam solution, where the foam proportioning device is operatively connected to both the internal collapsible bag of the firefighting foam in a bag apparatus and a water supply; and a discharge device configured to apply the foam solution to a fire-affected area, where the discharge device is operatively coupled to the foam proportioning device.

In general, in another embodiment, the disclosure features a firefighting foam in a bag apparatus, including an outer container configured to provide structural support and protection, where the outer container comprises an aperture for accessing the contents within; an internal collapsible bag disposed within the outer container, where the internal collapsible bag is configured to store a foam concentrate, collapse as the foam concentrate is dispensed, and prevent air exposure to maintain integrity of the foam concentrate; and a connection mechanism for detachably securing the internal collapsible bag within the outer container, where the connection mechanism includes a locking collar and mating connectors to facilitate secure attachment and detachment of the internal collapsible bag.

In general, in another embodiment, the disclosure features a method for using a firefighting foam in a bag system, including the steps of attaching an internal collapsible bag containing foam concentrate within an outer container, where the internal collapsible bag is configured to collapse as foam concentrate is dispensed; connecting the internal collapsible bag to a foam proportioning device; activating a water supply and the foam proportioning device to mix the foam concentrate from the internal collapsible bag with water to create a foam solution; conveying the foam solution to a discharge device; and applying the foam solution to a fire-affected area using the discharge device.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a schematic diagram of a firefighting foam in a bag apparatus, in accordance with certain embodiments of the present disclosure.

FIG. 2 depicts the firefighting foam in a bag system in operation, including a water supply, proportioning device, foam solution, discharge device, and finished foam, in accordance with certain embodiments of the present disclosure.

FIG. 3 depicts a working embodiment of a firefighting foam in a bag apparatus, in accordance with certain embodiments of the present disclosure.

FIGS. 4A-4C depict CAD drawings of the full assembly of a firefighting foam in a bag apparatus, in accordance with certain embodiments of the present disclosure. FIG. 4A depicts the full assembly of a firefighting foam in a bag apparatus. FIG. 4B depicts the full assembly of a firefighting foam in a bag apparatus. FIG. 4C depicts a cross-section of the full assembly of a firefighting foam in a bag apparatus.

FIG. 5 depicts a CAD drawing of the assembly of a firefighting foam in a bag apparatus, containing the body portion, top cap, thread, bottom cap, and stand cap, in accordance with certain embodiments of the present disclosure.

FIGS. 6A-6C depict CAD drawings of the body portion of a firefighting foam in a bag apparatus, in accordance with certain embodiments of the present disclosure. FIG. 6A depicts a perspective side view of the body portion of a firefighting foam in a bag apparatus. FIG. 6B depicts a side view the body portion of a firefighting foam in a bag apparatus. FIG. 6C depicts the top view of the body portion of a firefighting foam in a bag apparatus.

FIGS. 7A-7D depict CAD drawings of the top cap portion of a firefighting foam in a bag apparatus, in accordance with certain embodiments of the present disclosure. FIG. 7A depicts a perspective side view of the top cap portion of a firefighting foam in a bag apparatus. FIG. 7B depicts a side view the top cap portion of a firefighting foam in a bag apparatus. FIG. 7C depicts a cross-sectional side view the top cap portion of a firefighting foam in a bag apparatus. FIG. 7D depicts the top view of the top cap portion of a firefighting foam in a bag apparatus.

FIGS. 8A-8B depict CAD drawings of the top cap portion of a firefighting foam in a bag apparatus, in accordance with certain embodiments of the present disclosure. FIG. 8A depicts the perspective view of the full top cap. FIG. 8B depicts the cross-sectional view of the full top cap.

FIG. 9 depicts a CAD drawing of the thread portion of a firefighting foam in a bag apparatus, in accordance with certain embodiments of the present disclosure. FIGS. 10A-10C depict CAD drawings of the bottom cap portion of a firefighting foam in a bag apparatus, in accordance with certain embodiments of the present disclosure. FIG. 10A depicts the perspective view of the full bottom cap. FIG. 10B depicts the perspective view of the line drawing of the full bottom cap. FIG. 10C depicts the cross-sectional view of the full bottom cap.

FIGS. 11A-11B depict CAD drawings of the bottom cap portion with an inside handle of a firefighting foam in a bag apparatus, in accordance with certain embodiments of the present disclosure. FIG. 11A depicts the perspective view of the full bottom cap with an inside handle. FIG. 11B depicts the cross-sectional view of the bottom cap with an inside handle. FIGS. 12A-12B depict CAD drawings of the stand cap portion of a firefighting foam in a bag apparatus, in accordance with certain embodiments of the present disclosure. FIG. 12A depicts the perspective view of the full stand cap. FIG. 12B depicts the cross-sectional view of the stand cap.

### NOTATION AND NOMENCLATURE

Various terms are used to refer to particular system components. Different companies may refer to a component by different names-this document does not intend to distinguish between components that differ in name but not function. In the following discussion and in the claims, the terms “including” and “comprising” are used in an open-ended fashion, and thus should be interpreted to mean “including” but not limited to Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

### DETAILED DESCRIPTION OF THE DISCLOSURE

The present disclosure is directed to a novel firefighting foam storage and application system, specifically designed to address the challenges associated with the use of fluorine-free foams in firefighting operations. This system includes a two-part container with a hard plastic outer shell and an internal collapsible bag, an application device that integrates with existing firefighting equipment, and methods for both the use and disposal of the foam in a bag. The system is engineered to minimize foam degradation due to oxygenation, limit personnel and equipment contact, and ensure compatibility with both legacy and fluorine-free foams.

The disclosure provides innovative, sustainable devices, methods, and systems for the storage, application, and disposal of firefighting foam, addressing the limitations of prior art by introducing a novel firefighting foam in a bag (FFIB) system. This system includes a two-part container, featuring a hard plastic outer shell and an internal collapsible bag, designed to limit environmental exposures and compatible with existing firefighting apparatus. The FFIB system also includes an application device that mixes the foam concentrate with water on demand, ensuring efficient and effective fire suppression. Additionally, the FFIB system offers a straightforward disposal method, where the used bag can be easily replaced, minimizing environmental impact and operational downtime. The FFIB system provides a reliable and efficient solution to the challenges posed by modern firefighting requirements.

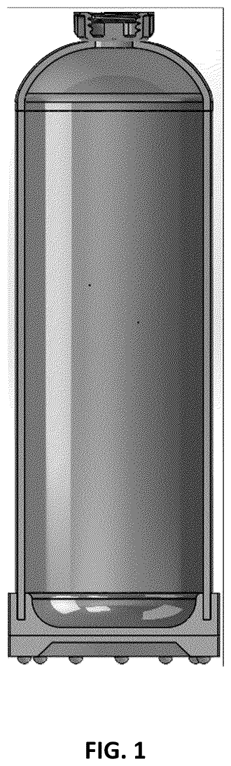

FIG. 1 depicts a schematic diagram of the Firefighter Foam in a Bag (FFIB) apparatus, showing the hard plastic outer container, the internal collapsible bag, the application device, and relevant connection points, in accordance with certain embodiments of the present disclosure. Specifically, FIG. 1 illustrates, in certain embodiments, a FFIB apparatus innovatively designed for firefighting operations, particularly suitable for the storage, application, and disposal of firefighting foam, including fluorine-free foams.

The FFIB apparatus, as shown in FIG. 1, includes a two-part container comprising a hard plastic outer shell and an internal collapsible bag. The outer shell provides structural support and protection, while the collapsible bag is designed to minimize foam degradation by preventing air exposure. In certain embodiments, the container is designed to be air limiting, thereby extending the shelf life of the foam and maintaining its efficacy over time.

At the core of the FFIB apparatus is an application device integrated with the FFIB container. When combined with existing proportioning systems, this device is capable of mixing the foam concentrate with water at a controlled rate, ensuring optimal foam consistency and effectiveness during firefighting operations. The application device can be connected to existing firefighting equipment, such as hoses and nozzles, allowing for a seamless integration with current firefighting protocols.

As shown in FIG. 1, the FFIB apparatus may include an aperture at an end of the outer shell, which in certain embodiments may facilitate the supply of foam concentrate stored within the interior collapsible bag to a proportioning device through a foam inlet.

The system incorporating and using the FFIB apparatus may, in certain embodiments, also be used in accordance with a method for easy disposal and replacement of the FFIB container. When the internal collapsible bag is nearing depletion, it can be quickly and safely removed and replaced with a new pre-filled bag, minimizing downtime and exposure to potentially hazardous materials. This process is facilitated by a simple connection mechanism, which allows for quick interchangeability of foam containers.

Designed for use in various firefighting environments, the FFIB apparatus offers several advantages over traditional foam storage and application methods.

In some embodiments, the FFIB apparatus can be air limiting. In the same and other alternative embodiments, the FFIB apparatus may contain a collapsible design that prevents foam oxidation, thereby extending the shelf life and maintaining the quality of both legacy and fluorine-free foams.

In some embodiments, the FFIB apparatus may contain additional features aimed at enhancing its operational efficiency and safety. For example, in some embodiments, the FFIB apparatus may include a secure locking mechanism to prevent accidental disconnection. As another example, in some embodiments, the FFIB apparatus may include a visual indicator to monitor foam levels within the container.

The FFIB apparatus design can also, in certain embodiments, minimize direct contact between firefighters and the foam, reducing the risk of exposure to potentially harmful chemicals and improving overall safety.

In certain embodiments, the FFIB container may include reinforced sections to withstand the rigors of firefighting operations, and an ergonomic handle for easy transport and handling. The internal collapsible bag may be made from materials resistant to chemical degradation, ensuring the long-term durability and reliability of the system.

For monitoring and predictive maintenance, in some embodiments, sensors may be integrated within the FFIB apparatus to track usage patterns, foam levels, and container integrity. In such an embodiment, this data can be used to schedule timely replacements and ensure that the system is always ready for deployment, further enhancing the reliability and effectiveness of firefighting operations.

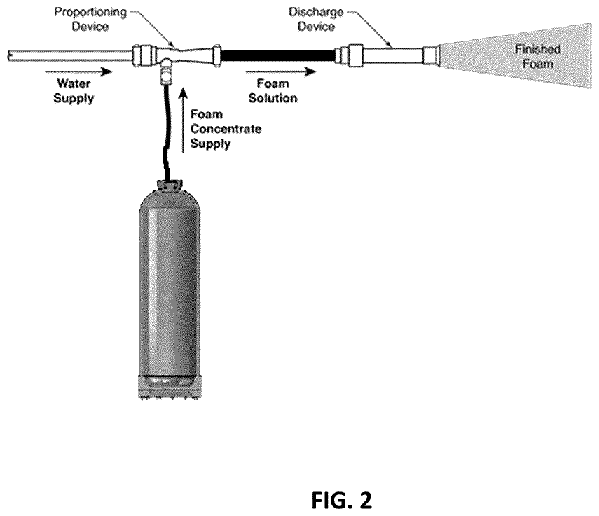

FIG. 2 depicts the firefighting foam in a bag system in operation, including a water supply, proportioning device, foam solution, discharge device, and finished foam, in accordance with certain embodiments of the present disclosure.

In some embodiments, as shown in FIG. 2, the FFIB apparatus of FIG. 1 may be utilized in conjunction additional system components, as disclosed in Appendices A-B.

In particular, as shown in FIG. 2, the FFIB system operates as an integrated firefighting solution. This figure demonstrates how the various components interact to produce and apply firefighting foam. The process begins with a water supply that feeds into the proportioning device.

As shown in FIG. 2, the FFIB system may include an operable connection between the FFIB apparatus and an a foam inlet of a proportioning device, which in certain embodiments may facilitate the supply of foam concentrate stored within the interior collapsible bag in the FFIB apparatus. The proportioning device may, in some embodiments and as depicted in FIG. 2, have an additional inlet for the intake of a water supply, which may combine with the foam concentrate supply to allow a foam solution to flow from an outlet of the proportioning device.

The proportioning device can thus, in certain embodiments, mix the water with the foam concentrate stored in the FFIB apparatus to create the foam solution. This foam solution is then conveyed to the discharge device, where it is applied as finished foam to combat fires.

In some embodiments, as shown in FIG. 2, the FFIB system may be utilized with standard firefighting equipment, making it compatible with a wide range of existing apparatus. The system is designed to be versatile and easy to integrate, ensuring that it can be quickly deployed in various firefighting scenarios.

Central to the depicted FFIB system, in the embodiments shown in FIG. 2, is the collapsible bag within the hard plastic outer container. In such an embodiment, as the water supply feeds into the proportioning device, the internal bag collapses, ensuring that the foam concentrate is efficiently utilized without air exposure, which can degrade the foam quality. The air limiting nature of the container prevents oxidation, thereby extending the shelf life of the foam.

The operation of the system is facilitated by a series of connection points and valves that allow for seamless integration with existing firefighting hoses and nozzles. The proportioning device is calibrated to mix the foam concentrate with water at a precise ratio, ensuring optimal foam quality and consistency. This foam solution is then directed through the discharge device, which can be a hose nozzle or any other suitable applicator, to effectively combat fires.

In some embodiments, based on its design for efficiency and ease of use, the FFIB system can offers several operational advantages. For example, in some embodiments, the plug-and-play design allows for quick setup and replacement of foam containers, minimizing downtime during firefighting operations. In the same and alternative embodiments of the FFIB system, the collapsible bag can reduce waste and ensures that all the foam concentrate is used efficiently.

Additional features of the FFIB system, aimed at enhancing its operational reliability and safety, can in certain embodiments include visual indicators for monitoring foam levels and secure locking mechanisms to prevent accidental disconnections.

In some preferred embodiments, the FFIB system's components are designed to withstand the demanding conditions of firefighting operations, ensuring durability and long-term reliability.

For enhanced monitoring and maintenance, the FFIB system may further include sensors integrated within and throughout the system to track usage, foam levels, and container integrity. In some embodiments, the FFIB system may include sensors to track integrity throughout the operation system during use and storage. In such embodiments, this data can be used to optimize the performance of the system and schedule timely replacements, ensuring that the FFIB system is always ready for deployment.

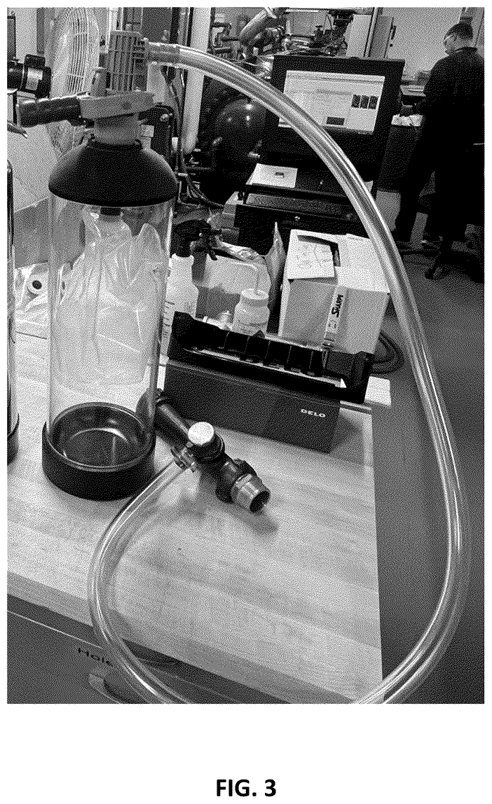

FIG. 3 depicts a working embodiment of a firefighting foam in a bag (FFIB) apparatus, illustrating the operational integration of the components detailed in FIGS. 1 and 2, in accordance with certain embodiments of the present disclosure.

As shown in FIG. 3, the FFIB system operates seamlessly within a firefighting scenario, demonstrating the practical application and interaction of its key components. The figure illustrates the connection of the water supply to the proportioning device, which accurately mixes the foam concentrate from the collapsible bag within the hard plastic outer container to create a foam solution. This foam solution is then directed to the discharge device, exemplifying the system's ability to produce and apply firefighting foam effectively.

In this working embodiment, the water supply feeds into the proportioning device, which is calibrated to maintain the correct mixing ratio between the water and the foam concentrate. The collapsible bag within the outer container collapses as the foam concentrate is drawn out, preventing air exposure and maintaining the integrity of the foam solution. The air limiting nature of the container ensures that the foam concentrate remains free from oxidation, thereby extending its shelf life and effectiveness.

The foam solution produced by the proportioning device is conveyed through a hose to the discharge device, which can include various types of nozzles or applicators. This setup allows for the efficient application of the foam solution onto fire-affected areas. The figure highlights the ease of integration of the FFIB system with existing firefighting equipment, demonstrating its versatility and compatibility.

Additionally, FIG. 3 shows the secure connection points and valves that facilitate the quick replacement of the FFIB container. When the foam concentrate in the current bag is depleted, a new pre-filled collapsible bag can be easily connected to the system, ensuring continuous operation without significant downtime. This feature is particularly beneficial in prolonged firefighting scenarios where a constant supply of foam is necessary.

The embodiment depicted in FIG. 3 also includes visual indicators for monitoring the foam level within the collapsible bag. These indicators provide real-time information to the firefighting personnel, allowing them to anticipate when a replacement bag will be needed. The secure locking mechanisms shown in the figure prevent accidental disconnection of the FFIB container during operation, enhancing the safety and reliability of the system.

As shown in the working embodiment of the FFIB system depicted in FIG. 3, the FFIB system components are constructed from durable materials that resist chemical degradation and physical wear. The integration of sensors within the system, as illustrated, enables the tracking of usage patterns, foam levels, and container integrity. This data can be used for predictive maintenance and to ensure that the system is always ready for deployment.

The working embodiment of the FFIB system shown in FIG. 3 demonstrates the practical application of the innovative features described in the preceding figures. The system's ability to produce, store, and apply firefighting foam efficiently, while maintaining compatibility with existing equipment, underscores its potential to enhance firefighting operations significantly. This embodiment highlights the FFIB system's comprehensive approach to addressing the challenges of foam storage, application, and disposal, providing a reliable and effective solution for modern firefighting needs.

In some embodiments, the use of the FFIB system can begin with the preparation phase. In this phase, in some embodiments, the first step can involve ensuring that the FFIB apparatus is equipped with the FFIB system. This includes attaching the collapsible bag within the hard plastic outer container to the proportioning device and connecting the system to the water supply. This preparation step is crucial to ensure that the FFIB system is ready for operation when needed.

In some embodiments, the method of use can further include an initiation phase. This step can involve activating the water supply and engaging the proportioning device. The proportioning device can mix the water with the foam concentrate stored in the collapsible bag to create a foam solution. The airtight nature of the collapsible bag can ensure that the foam concentrate is protected from oxidation and maintains its effectiveness during this process.

In some embodiments, the method of use can further continue with the application phase. In this step, the foam solution can be conveyed through a hose to the discharge device. The discharge device can be, but is not limited to, a nozzle or another type of applicator suitable for firefighting. The foam solution can then be applied to the fire-affected area, providing effective suppression and preventing fire burn back.

In some embodiments, the method of use can further include the monitoring phase. During this phase, firefighters can monitor the foam level within the collapsible bag using visual indicators integrated into the FFIB system. These indicators provide real-time information on the remaining foam concentrate, allowing for timely decisions regarding the replacement of the FFIB container.

In some embodiments, the method of use can further include the replacement phase. Once the foam concentrate in the current collapsible bag is nearly depleted, the bag can be safely disconnected from the system. A new pre-filled collapsible bag can then be connected to the proportioning device, ensuring continuous operation without significant downtime. This quick replacement process minimizes exposure to potentially hazardous materials and maintains the efficiency of firefighting operations.

In some embodiments, the method of use can further include the disposal phase. In this step, the used collapsible bag can be disposed of according to environmental regulations and safety guidelines. The hard plastic outer container can be reused with a new collapsible bag, making the system cost-effective and environmentally friendly. Proper disposal of the used bag ensures that any residual foam concentrate does not pose an environmental hazard.

In some embodiments, the method of use can further include the maintenance phase. During this phase, regular checks can be conducted on the FFIB system to ensure all components are functioning correctly. In such an embodiment, this step can include inspecting the proportioning device, the connection points, and the discharge device. Sensors integrated within the system provide data on usage patterns and container integrity, enabling predictive maintenance and ensuring that the FFIB system is always ready for deployment.

In some embodiments, the method of use can further include the review phase. After each firefighting operation, a review can be conducted to assess the performance of the FFIB system. Feedback from firefighters is collected to identify any areas for improvement. This continuous improvement process can ensure that the FFIB system evolves to meet the changing needs of firefighting operations and maintains its effectiveness in various scenarios.

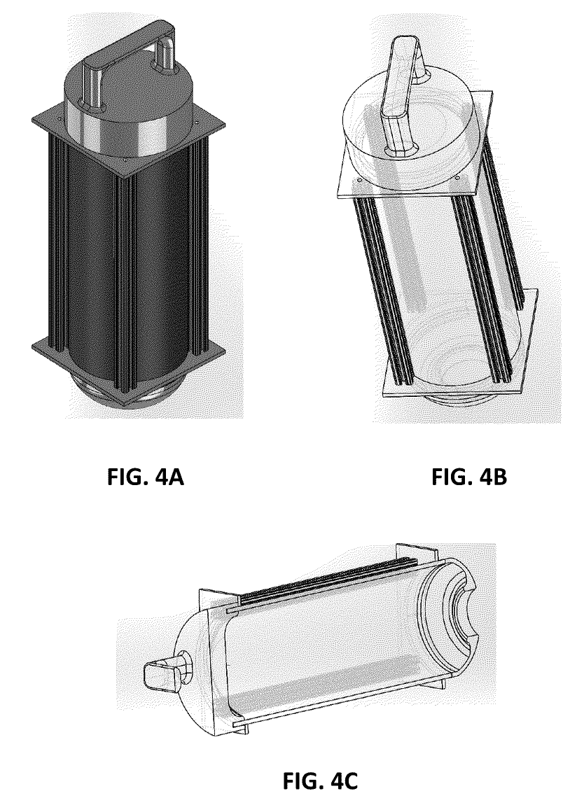

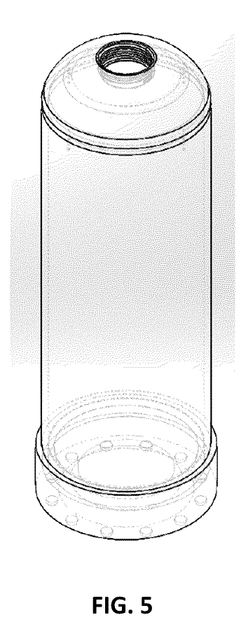

In some embodiments, the FFIB system is made up of a body portion, top cap, thread, bottom cap, and stand cap. In accordance with certain embodiments, the configuration can be that shown in FIGS. 4A-4C and FIG. 5.

Specifically, FIGS. 4A-4C depict CAD drawings of the full assembly of a firefighting foam in a bag apparatus. FIG. 4A depicts the full assembly of a firefighting foam in a bag apparatus. FIG. 4B depicts the full assembly of a firefighting foam in a bag apparatus. FIG. 4C depicts a cross-section of the full assembly of a firefighting foam in a bag apparatus.

Accordingly, FIGS. 4A-4C illustrate various views of a FFIB apparatus in its assembled configuration, in accordance with certain embodiments of the present disclosure.

FIG. 4A shows a perspective view of the assembled FFIB apparatus. The apparatus can include a body portion, a top cap, a bottom cap, and a stand cap. As shown in the embodiment of FIGS. 4A-4C, the body portion can be generally cylindrical and defines an internal volume configured to receive a collapsible inner bag for containing firefighting foam concentrate. The top cap can be secured to a proximal end of the body portion via threaded engagement and includes an outlet port for connecting to a foam proportioning device. The bottom cap can be attached to the distal end of the body portion and provides closure and structural reinforcement. A stand cap can be coupled beneath the bottom cap and forms a stable base for upright positioning during transport, storage, and use.

FIG. 4B provides a side elevation view of the FFIB apparatus. This view shows the vertical alignment of the top cap, body portion, bottom cap, and stand cap along a central longitudinal axis. The threaded region between the body portion and the top cap is shown as extending downward from the upper rim of the apparatus, ensuring a secure seal. The stand cap extends laterally beyond the outer diameter of the body portion, enhancing stability and reducing the risk of tipping when the apparatus is positioned vertically on a support surface.

FIG. 4C depicts a longitudinal cross-sectional view of the assembled FFIB apparatus. The cross-section illustrates the interior cavity of the body portion in which the collapsible bag can be housed. The top cap includes a foam conduit extending from the outlet port into the interior, enabling the controlled withdrawal of foam concentrate. In some embodiments, the outlet port can be fitted with a valve, check seal, or quick-connect fitting to interface with a proportioning system. The body portion may further include internal support ribs or alignment features to maintain the position of the collapsible bag and prevent deformation during operation. The bottom cap may incorporate an inside handle or seat to cradle the lower end of the collapsible bag. The stand cap can include a widened base and may optionally include drainage holes or gripping surfaces to support safe handling.

Together, FIGS. 4A-4C demonstrate the structural arrangement and functional integration of the components of the FFIB apparatus. In operation, as foam concentrate is withdrawn through the outlet port, the collapsible bag can contract, minimizing air ingress and thereby reducing oxidation and maintaining foam integrity. The rigid outer shell formed by the body portion, top cap, and bottom cap can, in some embodiments, protect the contents from mechanical damage and environmental exposure, while the stand cap can ensure upright stability in field conditions.

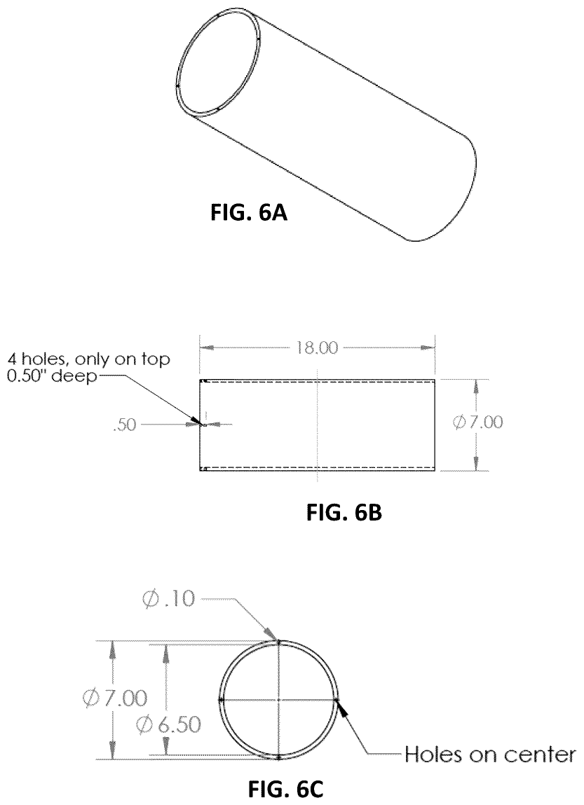

FIG. 5 depicts a CAD drawing of the assembly of a firefighting foam in a bag apparatus, containing the body portion, top cap, thread, bottom cap, and stand cap. FIG. 5 shows an exploded view of the firefighting foam in a bag apparatus, illustrating the primary structural components in disassembled form. FIG. 5 includes the body portion, top cap, thread insert, bottom cap, and stand cap. As shown by FIG. 5, in some embodiments, each part of the apparatus (such as, for example, but not limited to those depicted in FIGS. 6A-6D, 7A-7D, 8A-8B, 9, 10A-10B, 11A-11B, and 12A-12B) interfaces within the overall assembly, including the top and bottom caps' alignment with the cylindrical body portion and the stand cap's role in supporting the apparatus from below. The threading component shown provides a means for securely fastening the top cap to the body portion, ensuring a fluid-tight and pressure-resistant seal.

In some embodiments, the FFIB system contains a body portion. For example, FIGS. 6A-6C depict CAD drawings of the body portion of a firefighting foam in a bag apparatus. FIG. 6A depicts a perspective side view of the body portion of a firefighting foam in a bag apparatus. FIG. 6B depicts a side view the body portion of a firefighting foam in a bag apparatus. FIG. 6C depicts the top view of the body portion of a firefighting foam in a bag apparatus.

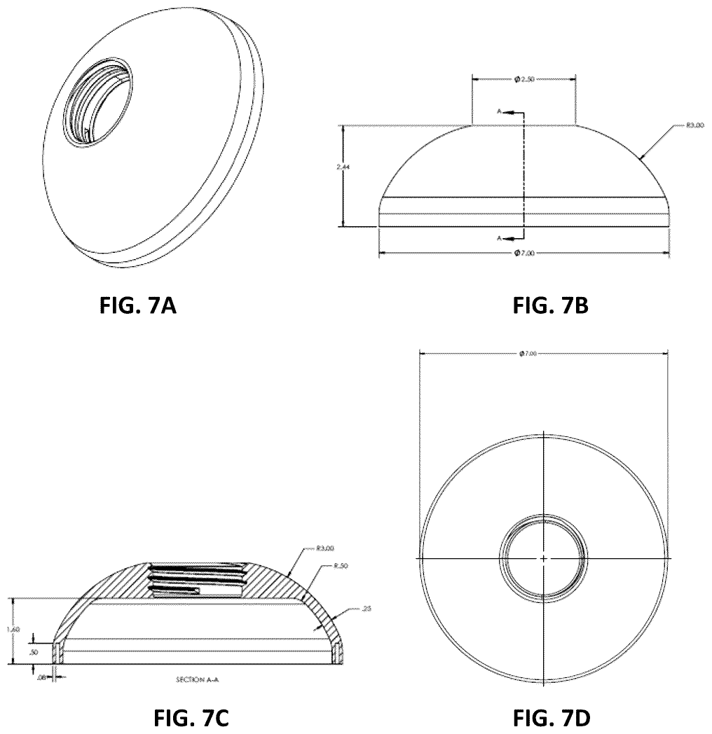

In some embodiments, the FFIB system contains a top cap portion. For example, FIGS. 7A-7D depict CAD drawings of the top cap portion of a firefighting foam in a bag apparatus. FIG. 7A depicts a perspective side view of the top cap portion of a firefighting foam in a bag apparatus. FIG. 7B depicts a side view the top cap portion of a firefighting foam in a bag apparatus. FIG. 7C depicts a cross-sectional side view the top cap portion of a firefighting foam in a bag apparatus. FIG. 7D depicts the top view of the top cap portion of a firefighting foam in a bag apparatus.

In some embodiments, the top cap portion can be affixed to the body portion, in accordance with the configuration displayed and depicted in FIGS. 4A-4D.

Accordingly, FIG. 7A presents a perspective view, while FIG. 7B shows a side view of the top cap. FIG. 7C provides a cross-sectional view of the cap, revealing the internal flow channel designed to carry foam concentrate from the internal bag to the outlet. FIG. 7D shows the top view, including any inlet or outlet interfaces and fastener locations. The top cap may include integrated connection points for coupling with proportioning systems or foam discharge equipment.

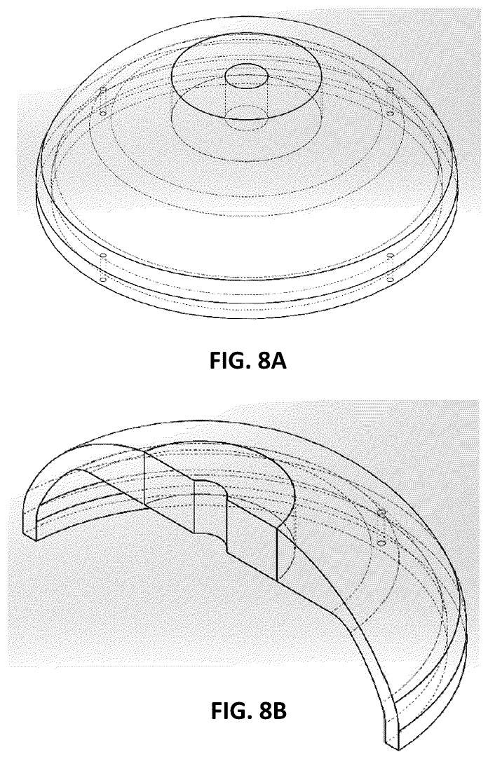

In some embodiments, the top cap portion can be configured in accordance with the structure shown in FIGS. 8A-8B.

FIGS. 8A and 8B offer additional views of the full top cap. FIG. 8A is a perspective view showing the complete outer profile of the cap. FIG. 8B provides a cross-sectional view, revealing the internal channel geometry and sealing surfaces. The top cap may include integrated valves, ports, or pressure control mechanisms depending on the embodiment.

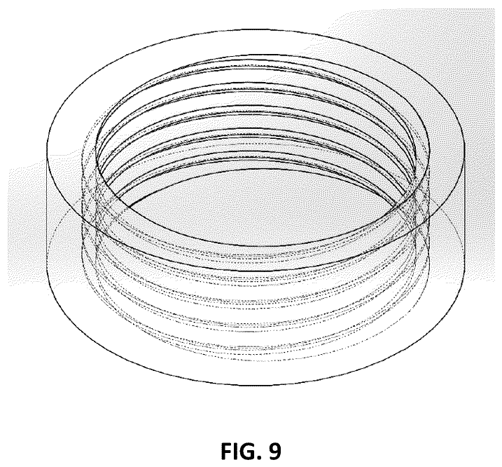

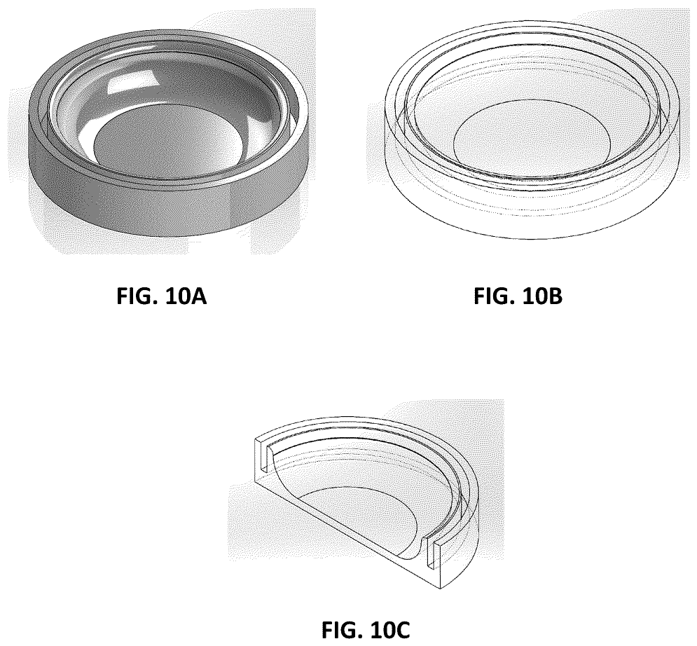

In some embodiments, the FFIB system contains a thread portion. For example, FIG. 9 depicts a CAD drawing of the thread portion of a firefighting foam in a bag apparatus. In some embodiments, the thread portion can be affixed in the assembly in accordance with the configuration displayed and depicted in FIGS. 4A-4D. The threading can allow for secure and repeatable attachment while maintaining a tight seal. As shown in FIG. 9, the thread portion can include an optimized the helical thread profile, axial depth, and outer diameter, which can be dimensioned to ensure structural stability and prevent leakage under pressure.

In some embodiments, the FFIB system contains a bottom cap portion. For example, FIGS. 10A-10C depict CAD drawings of the bottom cap portion of a firefighting foam in a bag apparatus. FIG. 10A depicts the perspective view of the full bottom cap. FIG. 10B depicts the perspective view of the line drawing of the full bottom cap. FIG. 10C depicts the cross-sectional view of the full bottom cap. In some embodiments, the bottom cap portion can be affixed in the assembly in accordance with the configuration displayed and depicted in FIGS. 4A-4D. In some embodiments, the bottom cap, as depicted in FIGS. 10A-10C can provide foundational structural support and may also assist with bag stabilization or pressure equalization.

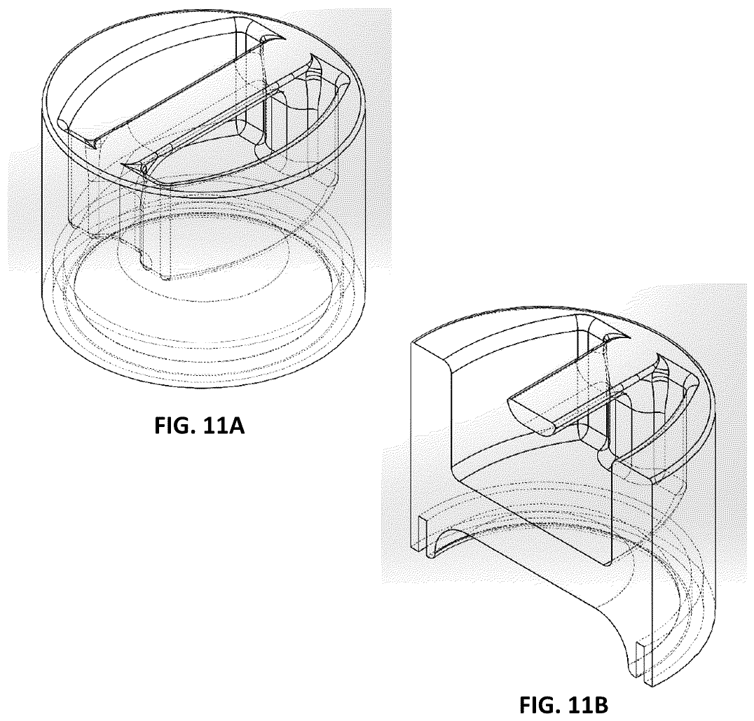

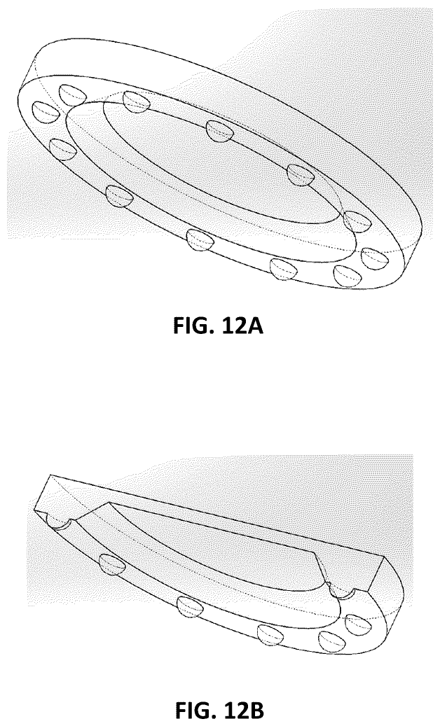

In some embodiments, the bottom cap portion can be configured to attach to an inner handle. For example, FIGS. 11A-11B depict CAD drawings of the bottom cap portion with an inside handle of a firefighting foam in a bag apparatus. FIG. 11A depicts the perspective view of the full bottom cap with an inside handle. FIG. 11B depicts the cross-sectional view of the bottom cap with an inside handle. In some embodiments, the internal handle can facilitate manual handling, insertion, or removal of the internal bag or entire unit, and can be particularly useful during disposal or replacement operations.

In some embodiments, the FFIB system contains a stand cap portion. For example, FIGS. 12A-12B depict CAD drawings of the stand cap portion of a firefighting foam in a bag apparatus. In some embodiments, the stand cap portion can be affixed in the assembly in accordance with the configuration displayed and depicted in FIGS. 4A-4D.

FIG. 12A shows a perspective view of the stand cap, which is shaped to support the full apparatus in an upright position. FIG. 12B presents a cross-sectional view showing the wall thickness, base width, and any structural supports or venting features. The stand cap may include reinforcement ribs or drainage ports to prevent fluid buildup during operation or transport.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical information may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that although the previous paragraphs relate to embodiments where steps may be described as occurring in a certain order, no ordering is required unless otherwise stated. In fact, steps described in the previous paragraphs may occur in any order. Furthermore, although one step may be described in one figure and another step may be described in another figure, embodiments of the present disclosure are not limited to such combinations, as any of the steps described above may be combined in particular embodiments.

Those skilled in the art will further appreciate that although the examples described above relate to embodiments where an artificial intelligence infrastructure supports the execution of machine learning models, the artificial intelligence infrastructure may support the execution of a broader class of Artificial Intelligence algorithms, including production algorithms. In fact, the steps described above may similarly apply to such a broader class of AI algorithms.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.
Clause 1. A firefighting foam in a bag system, comprising a firefighting foam in a bag apparatus, wherein the firefighting foam in a bag apparatus comprises: an outer container configured to provide structural support and protection, an internal collapsible bag disposed within the outer container, wherein the internal collapsible bag is configured to store foam concentrate and to collapse as foam concentrate is dispensed, and a connection mechanism for detachably securing the internal collapsible bag within the outer container; a foam proportioning device configured to mix the foam concentrate from the internal collapsible bag with water to create a foam solution, wherein the foam proportioning device is operatively connected to both the internal collapsible bag of the firefighting foam in a bag apparatus and a water supply; and a discharge device configured to apply the foam solution to a fire-affected area, wherein the discharge device is operatively coupled to the foam proportioning device.
Clause 2. The system of any foregoing clause, wherein the outer container is made of hard plastic.
Clause 3. The system of any foregoing clause, wherein the outer container comprises one or more reinforced sections.
Clause 4. The system of any foregoing clause, wherein the internal collapsible bag is made from materials resistant to chemical degradation.
Clause 5. The system of any foregoing clause, further comprising a secure locking mechanism to prevent accidental disconnection of the internal collapsible bag from the foam proportioning device.
Clause 6. The system of any foregoing clause, wherein the foam proportioning device is calibrated to mix the foam concentrate with water at a ratio to ensure optimal foam quality and consistency.
Clause 7. The system of any foregoing clause, further comprising sensors integrated within the firefighting foam in a bag apparatus.
Clause 8. The system of any foregoing clause, wherein the sensors are configured to track usage patterns, foam levels, and container integrity.
Clause 9. The system of any foregoing clause, wherein the discharge device comprises a hose nozzle for firefighting applications.
Clause 10. The system of any foregoing clause, further comprising an ergonomic handle on the outer container of the firefighting foam in a bag apparatus.
Clause 11. A firefighting foam in a bag apparatus, comprising an outer container configured to provide structural support and protection, wherein the outer container comprises an aperture for accessing the contents within; an internal collapsible bag disposed within the outer container, wherein the internal collapsible bag is configured to: store a foam concentrate, collapse as the foam concentrate is dispensed, and prevent air exposure to maintain integrity of the foam concentrate; and a connection mechanism for detachably securing the internal collapsible bag within the outer container, wherein the connection mechanism comprises a locking collar and mating connectors to facilitate secure attachment and detachment of the internal collapsible bag.
Clause 12. The apparatus of any foregoing clause, wherein the outer container is made of hard plastic.
Clause 13. The apparatus of any foregoing clause, wherein the outer container comprises one or more reinforced sections.
Clause 14. The apparatus of any foregoing clause, wherein the internal collapsible bag is made from materials resistant to chemical degradation.
Clause 15. The apparatus of any foregoing clause, wherein the internal collapsible bag further comprises multiple layers of material, wherein the multiple layers of material comprise an inner barrier layer and an outer protective layer.
Clause 16. The apparatus of any foregoing clause, wherein the connection mechanism further includes a secure locking mechanism with a latch or snap fit to prevent accidental disconnection during operation.
Clause 17. The apparatus of any foregoing clause, further comprising a visual indicator integrated into the outer container to monitor the foam concentrate within the internal collapsible bag.
Clause 18. The apparatus of any foregoing clause, wherein the aperture in the outer container is equipped with a sealing cap to protect the internal collapsible bag from environmental contaminants when not in use.
Clause 19. The apparatus of any foregoing clause, further comprising an ergonomic handle on the outer container.
Clause 20. A method for using a firefighting foam in a bag system, comprising the steps of attaching an internal collapsible bag containing foam concentrate within an outer container, wherein the internal collapsible bag is configured to collapse as foam concentrate is dispensed; connecting the internal collapsible bag to a foam proportioning device; activating a water supply and the foam proportioning device to mix the foam concentrate from the internal collapsible bag with water to create a foam solution; conveying the foam solution to a discharge device; and applying the foam solution to a fire-affected area using the discharge device.
Clause 21. The method of any foregoing clause, further comprising the step of monitoring the foam level within the internal collapsible bag using a visual indicator integrated into the outer container.
Clause 22. The method of any foregoing clause, wherein the step of attaching the internal collapsible bag includes securing the bag with a connection mechanism comprising a locking collar and mating connectors.
Clause 23. The method of any foregoing clause, further comprising the step of replacing the internal collapsible bag when the foam concentrate is depleted by detaching the empty bag and attaching a new pre-filled collapsible bag.
Clause 24. The method of any foregoing clause, wherein the step of connecting the internal collapsible bag to the foam proportioning device includes engaging a secure locking mechanism to prevent accidental disconnection.
Clause 25. The method of any foregoing clause, further comprising the step of calibrating the foam proportioning device to mix the foam concentrate with water at a precise ratio to ensure optimal foam quality and consistency.
Clause 26. The method of any foregoing clause, wherein the step of applying the foam solution includes directing the foam solution through a hose nozzle suitable for firefighting applications.
Clause 27. The method of any foregoing clause, further comprising the step of inspecting the firefighting foam in a bag apparatus for any signs of wear or damage before use to ensure operational readiness.
Clause 28. The method of any foregoing clause, further comprising the step of disposing of the used internal collapsible bag according to environmental regulations and safety guidelines.
Clause 29. The method of any foregoing clause, wherein the step of monitoring the foam level includes utilizing sensors integrated within the firefighting foam in a bag apparatus to track usage patterns and container integrity.
Clause 30. The method of any foregoing clause, further comprising the step of performing maintenance on the foam proportioning device and discharge device to ensure they are free of obstructions.
Clause 31. The method of any foregoing clause, further comprising the step of storing the firefighting foam in a bag apparatus in a cool, dry place to maintain the integrity and shelf life of the foam concentrate.

What is claimed is:

1. A firefighting foam in a bag system, comprising:
(a) a firefighting foam in a bag apparatus, wherein the firefighting foam in a bag apparatus comprises:
(i) an outer container configured to provide structural support and protection,
(ii) an internal collapsible bag disposed within the outer container, wherein the internal collapsible bag is configured to store foam concentrate and to collapse as foam concentrate is dispensed, and
(iii) a connection mechanism for detachably securing the internal collapsible bag within the outer container;
(b) a foam proportioning device configured to mix the foam concentrate from the internal collapsible bag with water to create a foam solution, wherein the foam proportioning device is operatively connected to both the internal collapsible bag of the firefighting foam in a bag apparatus and a water supply; and
(c) a discharge device configured to apply the foam solution to a fire-affected area, wherein the discharge device is operatively coupled to the foam proportioning device.

2. The system of claim 1, wherein the outer container is made of hard plastic.

3. The system of claim 1, wherein the outer container comprises one or more reinforced sections.

4. The system of claim 1, wherein the internal collapsible bag is made from materials resistant to chemical degradation.

5. The system of claim 1 further comprising a secure locking mechanism to prevent accidental disconnection of the internal collapsible bag from the foam proportioning device.

6. The system of claim 1, wherein the foam proportioning device is calibrated to mix the foam concentrate with water at a ratio to ensure optimal foam quality and consistency.

7. The system of claim 1 further comprising sensors integrated within the firefighting foam in a bag apparatus.

8. The system of claim 1, wherein the sensors are configured to track usage patterns, foam levels, and container integrity.

9. The system of claim 1, wherein the discharge device comprises a hose nozzle for firefighting applications.

10. The system of claim 1 further comprising an ergonomic handle on the outer container of the firefighting foam in a bag apparatus.

11. A firefighting foam in a bag apparatus, comprising:
(a) an outer container configured to provide structural support and protection, wherein the outer container comprises an aperture for accessing the contents within;
(b) an internal collapsible bag disposed within the outer container, wherein the internal collapsible bag is configured to:
(i) store a foam concentrate,
(ii) collapse as the foam concentrate is dispensed, and
(iii) preventing air exposure to maintaining integrity of the foam concentrate; and
(c) a connection mechanism for detachably securing the internal collapsible bag within the outer container, wherein the connection mechanism comprises a locking collar and mating connectors to facilitate secure attachment and detachment of the internal collapsible bag.

12. The apparatus of claim 11, wherein the outer container is made of hard plastic.

13. The apparatus of claim 11, wherein the outer container comprises one or more reinforced sections.

14. The apparatus of claim 11, wherein the internal collapsible bag is made from materials resistant to chemical degradation.

15. The apparatus of claim 11, wherein the internal collapsible bag further comprises multiple layers of material, wherein the multiple layers of material comprise an inner barrier layer and an outer protective layer.

16. The apparatus of claim 11, herein the connection mechanism further includes a secure locking mechanism with a latch or snap fit to prevent accidental disconnection during operation.

17. The apparatus of claim 11 further comprising a visual indicator integrated into the outer container to monitor the foam concentrate within the internal collapsible bag.

18. The apparatus of claim 11, wherein the aperture in the outer container is equipped with a sealing cap to protect the internal collapsible bag from environmental contaminants when not in use.

19. The apparatus of claim 11 further comprising an ergonomic handle on the outer container.

20. A method for using a firefighting foam in a bag system, comprising the steps of:
(a) attaching an internal collapsible bag containing foam concentrate within an outer container, wherein the internal collapsible bag is configured to collapse as foam concentrate is dispensed;
(b) connecting the internal collapsible bag to a foam proportioning device;
(c) activating a water supply and the foam proportioning device to mix the foam concentrate from the internal collapsible bag with water to create a foam solution;
(d) conveying the foam solution to a discharge device; and
(e) applying the foam solution to a fire-affected area using the discharge device.
